(19) United States
(12) Patent Application Publication
(10) Pub. No.: US 2020/0013264 A1
(43) Pub. Date: Jan. 9, 2020

(54) SAFETY DROP CLOTH

(71) Applicant: Monica BASTIDAS, (US)

(72) Inventor: David BASTIDAS, Pacifica, CA (US)

(73) Assignee: Monica BASTIDAS, Pacifica, CA (US)

(21) Appl. No.: 16/547,490

(22) Filed: Aug. 21, 2019

Related U.S. Application Data
(63) Continuation of application No. 15/478,159, filed on Apr. 3, 2017, now abandoned.
Application No. 15/478,159 is a continuation-in-part of application No. 15/079,014, filed on Mar. 23, 2016, now abandoned.
Application No. 15/079,014 is a continuation of application No. 14/245,263, filed on Apr. 4, 2014, now abandoned.

(30) Foreign Application Priority Data
Apr. 23, 2013 (GB) 1307288.9

(51) Int. Cl. G08B 7/06; G08B 21/18; H04W 68/00

(52) U.S. Cl. CPC G08B 7/06; H04W 68/005; G08B 21/182

(57) ABSTRACT

Interactive drop cloths are disclosed herein. An example interactive drop cloth includes a safety drop cloth, one or more audio output devices integrated into one or more corners of the safety drop cloth, and a controller that causes an audible alert message to be output by the one or more audio output devices.

### CROSS REFERENCE TO RELATED APPLICATIONS

The present application is a continuation of U.S. patent application Ser. No. 15/478,159, filed Apr. 3, 2017, which is a continuation-in-part of U.S. patent application Ser. No. 15/079,014, filed on Mar. 23 2016, which is a continuation of U.S. patent application Ser. No. 14/245,263, filed Apr. 4, 2014, which claims the benefit and priority under 35 U.S.C. 119 to UK Patent Application No. 130288.9, filed Apr. 23, 2013, the entire contents of each of the aforementioned applications are incorporated by reference as if fully set forth.

### FIELD OF THE INVENTION

The present invention relates to a safety drop cloth, more particularly but not exclusively a drop cloth for providing a safe area that uses proximity sensing (and proximity based alert triggering), audio and/or visual alert messaging, and operational configuration through an application.

### BACKGROUND

Increasing levels of health and safety awareness in many fields has led to many problems, in regulation, adherence and working conditions. Problems often stem from where heightened awareness and need for compliance is contemporaneous with lack of resources.

In particular in many societies many sites have been constructed or improved or otherwise date from earlier health and safety regimes, and/or are subsequently subjected to more rigorous conditions for use than originally intended.

In consequence many sites often require on going maintenance and restructuring, and such maintenance is often required in sites that have continuing usage, and wherein it is impractical or impossible to halt such usage for a period of time so as to accommodate maintenance or health and safety requirements prompted by such maintenance.

Accordingly a number of patent applications have been filed in an attempt to resolve the problem or similar, including the following:

Granted United States patent U.S. Pat. No. 8,176,685 (MAY) discloses a protective sheet and method for protecting an object is disclosed. The protective sheet or drop cloth is made from a blend comprising ethylene vinyl acetate (EVA) and polyethylene (PE), making it naturally liquid impervious and slip resistant. The protective sheet includes a top side having a raised surface design configured for retaining fluid, and a bottom side that is smoother than the top side for added slip resistance. The method comprises the steps of providing the protective sheet and positioning it over the object, wherein the top side faces away from the object, and the bottom side faces the object and the top side is available for a workman to walk on.

Granted United Kingdom patent GB 2 406 050 (HOLTBY) discloses a safety mat, comprising: a polygonal planar body having an upper liquid collecting surface, a bottom surface, and several peripheral edges; a plurality of closely spaced truncated projections of uniform height positioned on the liquid collecting surface, the truncated projections forming a high traction travel surface that is raised above any accumulated liquids on the liquid collecting surface.

Granted European patent EP 1 131 806 (EVANS) discloses a signage arrangement comprising a length of flexible sheet material, the length of flexible sheet material: i) carrying a signage indicium; ii) being capable of being wound in a roll by manual force; and, iii) having an arrangement of a multiplicity of apertures through the sheet material.

### SUMMARY

According to the present disclosure, embodiments disclosed herein are directed to a device, comprising: (a) a safety drop cloth comprising a first face, and a reverse second face, wherein the second face substantially contacts with a subordinate surface in use, and the first face comprises a body and periphery arranged with demarcation, comprising retro-reflective material, to distinguish said periphery from said body by light transmission characteristics; (b) one or more audio output devices integrated into one or more corners of the safety drop cloth; and (c) a controller that causes an audible alert message to be output by the one or more audio output devices.

According to the present disclosure, embodiments disclosed herein are directed to a device, comprising: (a) a safety drop cloth comprising a first face, and a reverse second face, wherein the second face substantially contacts with a subordinate surface in use, and the first face comprises a body and periphery arranged with demarcation, comprising retro-reflective material, to distinguish said periphery from said body by light transmission characteristics; (b) a communications interface; and (c) a controller that causes an alert message to be transmitted to one or more mobile devices in proximity to the safety drop cloth via the communications interface.

According to the present disclosure, embodiments disclosed herein are directed to a device, comprising: (a) a safety drop cloth comprising a first face, and a reverse second face, wherein the second face substantially contacts with a subordinate surface in use, and the first face comprises a body and periphery arranged with demarcation, comprising retro-reflective material, to distinguish said periphery from said body by light transmission characteristics; (b) a visual indicator comprising light emitting diodes capable of emitting light in one or a plurality of colors; and (c) a controller that causes the visual indicator to display an alert message in a form of a color, the color being associated with a hazard for which the safety drop cloth has been deployed.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings embodiments that are presently preferred. It is understood, however, that the invention is not limited to the precise arrangements and instrumentalities shown. In the drawings:

FIG. 1 shows an isometric view of a preferred embodiment of the safety drop cloth.

FIG. 2 shows a perspective view of the embodiment shown in FIG. 1 from one end.

FIG. 3 shows a plan view of a second embodiment of the safety drop cloth showing its first face.

FIG. 4 shows an isometric view of the embodiment shown in FIG. 1.

FIG. 5 is a plan view of an embodiment comprising audio output devices.

FIG. 6 is a plan view of another embodiment comprising a visual indicator.

FIG. 7 is a schematic diagram of an embodiment of a drop cloth sensing proximity of an individual and transmitting an alert message to a mobile device.

FIG. 8 is a schematic diagram of an example drop cloth device.

### DETAILED DESCRIPTION OF THE PREFERRED EMBODIMENTS

### Introduction to the Embodiments

In preferred embodiments these superior light transmission characteristics comprise retro-reflective, fluorescent, luminescent or phosphorescent demarcations that demarcate at least the periphery and in some embodiments sections of the body.

In this way the cloth provides a safety drop cloth for use in areas with through passage of persons requiring warning of a hazard, be it a temporary or semi-permanent hazard, said areas typically including such as construction sites, occupied sites and during maintenance work of existing buildings in use, for example institutional or public buildings.

In preferred embodiments the body additionally comprises further parts of superior light transmission characteristics, or demarcation, for example wherein the body includes a number of strips arranged in a pattern drawing attention to the body's width and/or length, such as hatching across the body, wherein the body in general is contrasting in light transmission characteristics, for example displaying light absorbent characteristics.

In preferred embodiments the drop cloth comprises woven fabric such as cotton canvas, allowing said cloth to be cleaned, washed, dried or otherwise subjectable to a plurality of conditions, and arranged such as to remain substantially undamaged.

In preferred embodiments the first face or cloth is provided with a water-resistant treatment or surface.

In some other embodiments said fabric comprises manmade fibres and/or includes strengthening or reinforcement fibres woven or otherwise comprised within or without the fabric.

In further embodiments the cloth comprises multiple plastic layers and includes outer layers of spun bonded polypropylene film bonded to an intermediate film of either a polyethylene film or a polypropylene film wherein said layers are thermally bonded to each other. Said spun bonded polypropylene film absorbs and transmits liquids such as paint, wood stains, paint thinners, solvents and the like and said polyethylene film and is impervious to such liquids so as to prevent transmission through the cloth of material absorbed by the outer layer.

In preferred embodiments said periphery or demarcation comprises strips of luminescent or fluorescent material, colouring or tape. Said strips may be comprised of analogous material to the body, wherein the strips may be painted, coloured or otherwise impregnated with material having light transmissive characteristics.

Said strips may be heat or adhesive bonded to the body, or may in some embodiments be stitched on to the body.

In some further embodiments the demarcation may comprise light storage attributes, wherein the periphery and/or strips may store energy received during periods of light to visibly release in low light levels, so as to increase visibility of the cloth in low light and increase safety even for poorly lit hazard areas, such attributes comprising a wear-resistant phosphorescent periphery or demarcation that emits light after removal of ambient light in the area, so as to be visible in event of a power failure or ambient lighting suspension.

The demarcation may also contain a bright contrasting pigment in other regions of the body so as to be visually distinctive under normal lighting conditions.

Advantageously in some further embodiments the periphery and/or body comprises high-visibility characteristics such as retro-reflective elements, or flecks. Said elements may comprise the strips, or may be incidental or additional to the strips and may comprise further demarcation.

For example in some embodiments the elements may comprise edging to the periphery, so as to allow reflection of light directed at the periphery edging by approaching light sources to be reflective ideally in a plurality of directions, such as light from passing vehicles and/or so as to alert passers-by of the cloth.

In further embodiments the elements may comprise flecking in or on the body, or stripping contiguous or analogous to the strips or demarcation.

Both faces may be provided with analogous demarcation, flecks, strips or elements; in order that either side may be used as required and to allow the faces to become damaged, dirtied or worn without detriment to safety.

In further, preferred, embodiments one of the faces is arranged permanently as the second face and provided with ground engagement means or enhanced friction attributes, in order that the cloth is not liable to movement in relation to the subordinate surface under movements engaging with the superior or first face.

For example the second face or cloth may comprise a slip resistant article such as an underpad or layered form comprising a moisture-absorbent layer and a water-impervious layer wherein the water-impervious layer is arranged with a treatment to provide a high coefficient of friction.

Said treatment may comprise a plurality of rubber, silicone or elastomer ribs, parts or nubs, said parts outstanding from the second face so as to engage in multiple places with the subordinate surface.

In such embodiments the second surface may comprise small closely spaced raised nubs spread over a face in an arrangement so as to permit softness of the cloth and allow flexibility therein as well as improve gripping characteristic of the cloth on one face at least.

Said nubs are ideally dispersed across or embodied in raised and lowered parts across the second face in order to allow movement and flexibility of the second face wherein lowered parts allow movement therebetween.

In preferred embodiments the body is in addition or the alternative provided with ribbing internally or on a face, wherein the ribbing is arranged to add shape and discourage ruching, bunching or displacement, or otherwise increase rigidity. Said ribbing may correspond to or be provided by the demarcation or may be comprised by the first or second face.

Said ribbing or nubs may be arranged in a single direction or arranged in orthogonal broken or unbroken lines arranged so as to create gridding, and/or enable greater flexibility of structure.

In addition or the alternative said ribbing may be arranged so as to encourage stiff sides and allow oblique, transverse or arcuate flexibility, for example wherein the ribbing radiates outwards from at least one point or is more or less prevalent towards the periphery.

In some embodiments the periphery is weighted wherein continuous or partial flexible weights are secured along at least two opposed edges of the periphery for securing the cloth against movement of air below or against the cloth. Sand, shot or other particulate or fluid material may be comprised in hems or tubes attached along the periphery within or subordinate to the strips or demarcation.

Weighting may be accomplished at the cloth's corners by displaceable or integrated weights, or corners and further may be secured by pins or pegs in use.

In this way the cloth may be encouraged to remain flat to the surface in use, wherein internal ribbing and/or external nubs may be arranged to minimise flexibility parallel to or perpendicular to the periphery.

In this way or other ways as described above to include nubs the cloth may be minimally prone to causation of a trip hazard in use and simultaneously better enabled to closely ride or cover uneven ground subordinate, without moving, folding, or other dangerous displacement liable to lead to either tripping of a user or passer-by, or problematic conditions for the user during work activities, which conditions may mean that for example a ladder may be difficult to securely or stably situate on the cloth.

In some embodiments the cloth may be made from insulated materials so as to aid in retaining warmth for improved working conditions and may include facility to allow electric heating so as to heat the subordinate surface, for example so as to enable curing of concrete.

In some further embodiments the cloth may comprise means to conjoin with or secure to other cloths and/or with further independent structures, for example including at least one tether, eyelet or lanyard attachment point or in yet further embodiments hook and loop portions, for example Velcro CD.

In some embodiments the cloth may include demarcation comprising periphery- or body-inset light emitting diodes, wherein a power source is integrated or subject to connection into the cloth.

In yet further embodiments there may be included pockets in the cloth, for example so as to allow storage and/or transport of smaller items according to the user's use of the cloth, and/or so as to store tethers, hooks or other securement means.

In still further embodiments the doth comprises wording thereon, for example to draw attention generally or specifically to warn caution of features of the cloth, subordinate surface or surrounding areas.

Said warning may be customisable at purchase or manufacture, and in some embodiments may comprise a writeable area on the body and/or periphery.

In some embodiments demarcation includes textured surfaces or otherwise raised and lowered parts so as to provide light characteristics in a plurality of directions.

In some embodiments the body is formed of a base layer with a periphery or demarcation rim defining a well, wherein a top layer is accommodated in said well to define the first surface and/or body.

### DETAILED DESCRIPTION

With reference to the figures the cloth provides two faces, a first demarcated face 1, and its reverse a subordinate surface contacting second face 2. Said second face is provided with surface contact texture wherein the second face comprises raised and lowered parts, portions or texture.

The periphery 4 comprises safety warning material, combining retro-reflective and fluorescent materials. The body 3 is further divided by further demarcation 5.

In the pictured embodiment all demarcation 4,5 is provided by strips of material sewn onto the first face 1, wherein said strips enable greater stiffness on the reverse or second face 2.

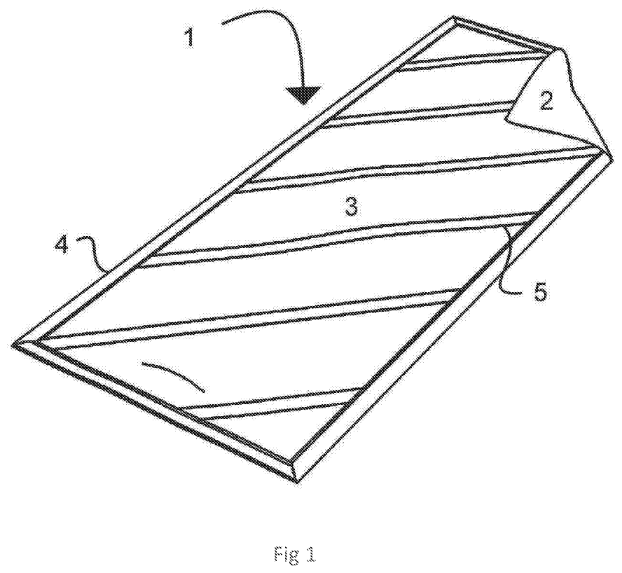

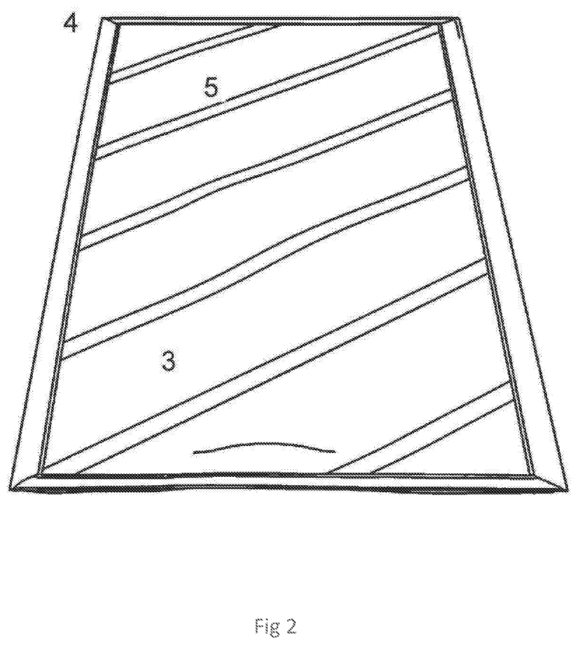

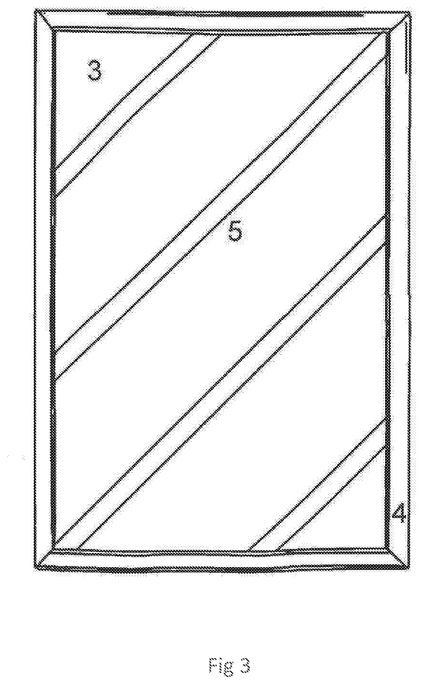

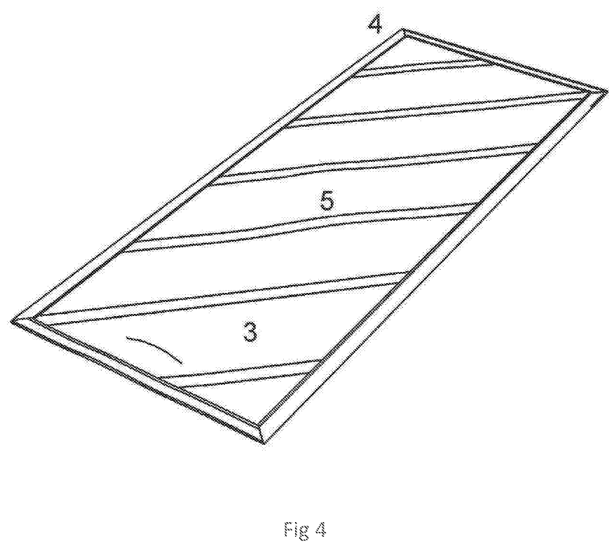

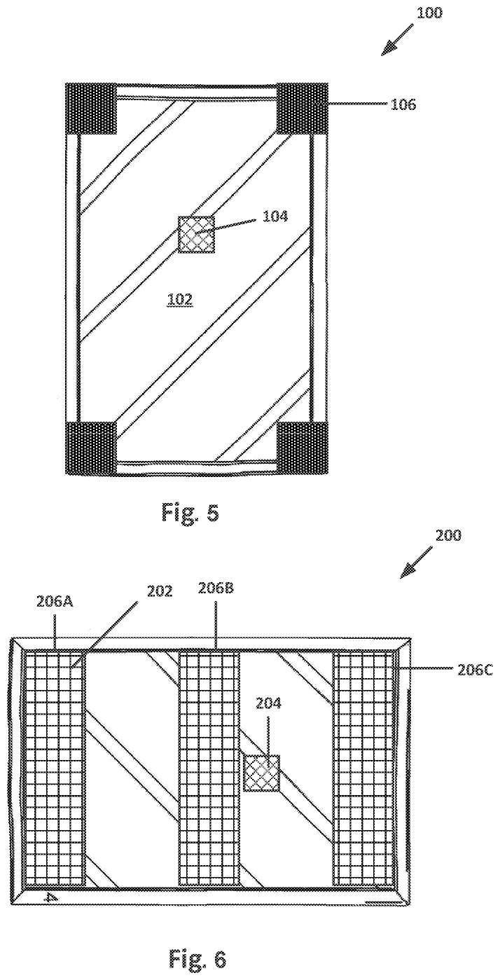

According to some embodiments, the present disclosure is directed to interactive drop cloths such as the interactive drop cloth 100 illustrated in FIG. 5. The interactive drop cloth 100 generally comprises a first face 102, a second face (back side not illustrated but similar to that shown in FIG. 1), a controller 104, and one or more audio output devices 106.

The interactive drop cloth 100 is manufactured from any desired textile described herein. In some embodiments the first face 102 comprises a body 108 and periphery arranged with demarcation. The first face 102 can comprise retro-reflective material to distinguish said periphery from said body by light transmission characteristics, or vice versa.

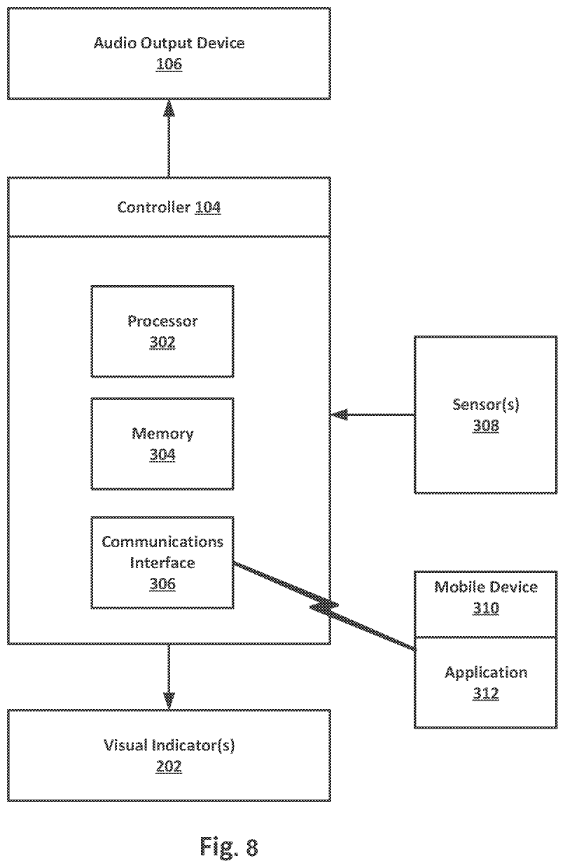

The controller 104 is described in greater detail with reference to FIG. 8, although generally the controller 104 is generally configured to transmit alert messages for output by the one or more audio output devices 106. In some embodiments the controller 104 can store instructions in memory that are executed by a microcontroller to cause the one or more audio output devices 106 to output an audible message such as “Caution”, “Watch your Step”, “Men working above”, “Caution Wet Paint” and so forth. In some embodiments, the audible alert message comprises audible content that is related to a hazard for which the safety drop cloth has been deployed such as “Caution, Wet Floor” when the interactive drop cloth 100 is deployed to cover a wet floor. In some embodiments, the controller 104 can be programmed by use of an application that executes on a computing device, as will be disclosed in greater detail with reference to FIG. 8.

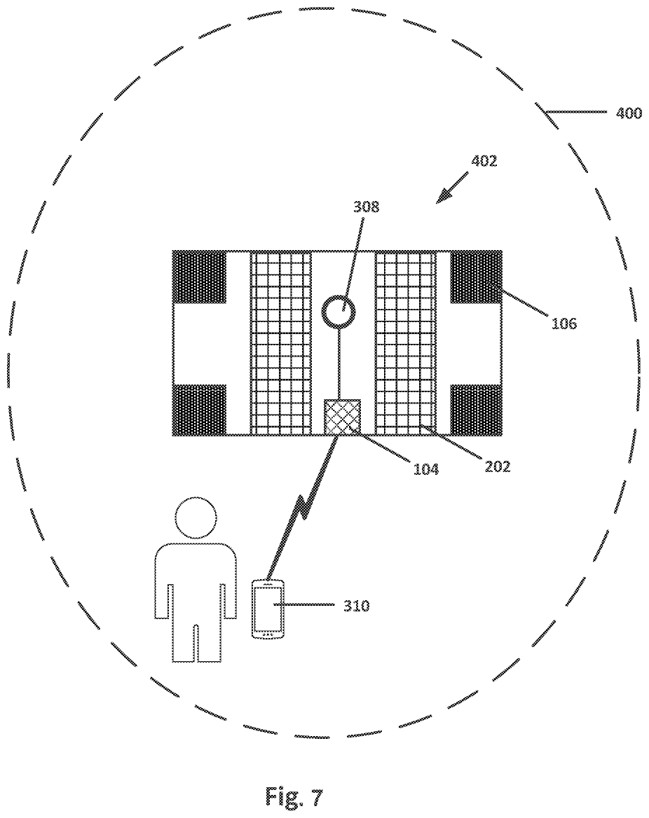

In some embodiments, the controller 104 can continually or periodically output the audible messages according to a predetermined schedule. In other embodiments, the controller 104 receives proximity signals from one or more sensors and causes the output of audible messages when an individual and/or device are in proximity to the interactive drop cloth 100. In some embodiments, the proximity sensors are located on the drop cloth (in the same manner for example as for proximity sensors 308 in FIG. 7).

The one or more audio output devices 106 can comprise speakers that are communicatively coupled with the controller 104. In some embodiments, the speakers are sewn into one or more corners of the interactive drop cloth 100. The one or more audio output devices 106 can add additional weight to the corners of the interactive drop cloth 100 to prevent unwanted movement of the interactive drop cloth 100.

FIG. 6 illustrates another interactive drop cloth 200 that comprises visual indicators, such as visual indicator 202 that is communicatively coupled with a controller 104.

The controller 104 is described in greater detail with reference to FIG. 8, although generally the controller 104 is generally configured to control operation of the visual indicators. In some embodiments the controller 104 can store instructions in memory that are executed by a microcontroller to cause the visual indicators to display one or more colors.

The visual indicator 202 can include a plurality of light emitting diodes that are mounted to the body of the interactive drop cloth 200. The LEDs can be arranged into a pattern such as the rectangles 206A-C illustrated. The LEDs can comprise multi-color LEDs that can be selectively changed. The rectangles 206A-C can be controlled independently from one another in some instances. While rectangular patterns have been illustrated other shapes and sizes are likewise contemplated, and can also include letters, numbers, and symbols. In some other embodiments, a single color LED is adopted.

In some embodiments, the color selected for operation of the LEDs is related to a hazard for which the interactive drop cloth 200 has been deployed. In some embodiments the color(s) can include any color selected from the OSHA (occupational safety and health administration) color code chart. In various embodiments, the controller 104 can be programmed by use of an application that executes on a computing device, as will be disclosed in greater detail with reference to FIG. 8.

Referring now to FIG. 8, a portion (e.g., electronics) of an example interactive drop cloth is illustrated. The controller 104 comprises a processor 302, a memory 304, and a communications interface 306. The controller 104 is illustrated in combination with the audio output device 106, the visual indicator 202, and sensor(s) 308. In some embodiments, the memory 304 stores executable instructions such as instructions used to control any of the audio output device 106 and/or the visual indicator 202. The instructions can also include methods for receiving and processing signals received from the sensor(s) 308.

The communications interface 306 can comprise utilize any wireless communications protocol such as a cellular, Bluetooth, near-field, or other similar protocols that allow the controller 104 to communicate with computing devices, such as a mobile device 310. The controller 104 transmits any of the audible alert message and another type of alert message to a mobile device 310 through the communications interface 306.

In various embodiments, the sensor(s) 308 can comprise proximity sensors, audio sensors, or other similar sensors that are used to sense the proximity of an individual or the mobile device 310 to an interactive drop cloth of the present disclosure. In other embodiments the sensor(s) 308 are used to establish a virtual fence or hazard zone and sense the presence of objects such as individuals or the mobile device 310 therein. In some embodiments, the sensor(s) 308 sense proximity of an individual to the interactive drop cloth and compare this proximity to a proximity threshold, such as ten feet. If the individual and/or the mobile device of the individual are within or closer than ten feet, alert messages are output by the interactive drop cloth such as colors or audible messages. Also, messages can be transmitted to the mobile device.

In one or more embodiments, the mobile device 310 executes an application 312 that allows a user to receive alert messages in textual, audio, or visual formats. In various embodiments application 312 allows a user to program features and operations of the controller 104 such as selecting alert messages, hazard events (and associated alert messages), LED color(s), establish hazard zone sizing, and so forth.

As illustrated in FIG. 7, in one embodiment, the sensor(s) 308 sense the presence of the mobile device 310 within a hazard zone 400 that is established around an example interactive drop cloth 402. The example interactive drop cloth 402 can include any interactive drop cloth described herein. When the mobile device 310 enters the hazard zone 400, a sensor of the interactive drop cloth 402 senses the presence of the mobile device 310 and/or individual and then outputs an audible alert “Danger” using the audio output device 106 while flashing red LED visual indicators (such as visual indicator 202) to warn the individual. Also, the controller 104 of the interactive drop cloth 402 transmits a similar (or different) alert message to the mobile device 310. For example, if the audible alert “Danger” is output by the interactive drop cloth 402, the controller 104 can also transmit a textual “Danger” message to the mobile device 310.

As mentioned above, the alert message comprises an audible alert message having audible content that is related to a hazard for which the safety drop cloth has been deployed.

The invention has been described by way of examples only and it will be appreciated that variation may be made to the above-mentioned embodiments without departing from the scope of invention. It will be appreciated that in other embodiments, the present technology combines one or more features of different embodiments shown in the accompanying figure and described herein By way of example, in some embodiments, the device can be a combination of the interactive drop cloth devices described and shown in two or more of any FIGS. 5, 6, 7 and 8 or other accompany figures.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A device, comprising:
a safety drop cloth comprising a first face, and a reverse second face, wherein the second face substantially contacts with a subordinate surface in use, and the first face comprises a body and periphery arranged with demarcation, comprising retro-reflective material, to distinguish said periphery from said body by light transmission characteristics;
one or more audio output devices integrated into one or more corners of the safety drop cloth; and
a controller that causes an audible alert message to be output by the one or more audio output devices.

2. The device according to claim 1, wherein the audible alert message comprises audible content that is related to a hazard for which the safety drop cloth has been deployed.

3. The device according to claim 1, further comprising one or more sensors that sense proximity of an individual to the safety drop cloth.

4. The device according to claim 3, wherein the audible alert message is output when the individual enters a hazard zone around the safety drop cloth.

5. The device according to claim 1, further comprising a communications interface in combination with the controller, wherein the controller transmits any of the audible alert message and another type of alert message to a mobile device through the communications interface,

6. The device according to claim 5, wherein the mobile device is located within in proximity to the safety drop cloth.

7. The device according to claim 1, further comprising a visual indicator comprising light emitting diodes capable of emitting light in a plurality of colors.

8. A device, comprising:
a safety drop cloth comprising a first face, and a reverse second face, wherein the second face substantially contacts with a subordinate surface in use, and the first face comprises a body and periphery arranged with demarcation, comprising retro-reflective material, to distinguish said periphery from said body by light transmission characteristics;
a communications interface; and
a controller that causes an alert message to be transmitted to one or more mobile devices in proximity to the safety drop cloth via the communications interface.

9. The device according to claim 8, wherein the alert message comprises an audible alert message having audible content that is related to a hazard for which the safety drop cloth has been deployed.

10. The device according to claim 9, further comprising one or more sensors that sense proximity of an individual to the safety drop cloth, wherein the alert message is transmitted when the individual enters a hazard zone around the safety drop cloth.

11. The device according to claim 10, further comprising a communications interface in combination with the controller, wherein the controller transmits any of the audible alert message and another type of alert message to the one or more mobile devices through the communications interface.

12. The device according to claim 8, further comprising a visual indicator comprising light emitting diodes capable of emitting light in a plurality of colors.

13. The device according to claim 8, wherein a zone of proximity for the safety drop cloth is based on a hazard for which the safety drop cloth has been deployed.

14. A device, comprising:
a safety drop cloth comprising a first face, and a reverse second face, wherein the second face substantially contacts with a subordinate surface in use, and the first face comprises a body and periphery arranged with demarcation, comprising retro-reflective material, to distinguish said periphery from said body by light transmission characteristics;
a visual indicator comprising light emitting diodes capable of emitting light in a plurality of colors; and
a controller that causes the visual indicator to display an alert message in a form of a color, the color being associated with a hazard for which the safety drop cloth has been deployed.

15. The device according to claim 14, further comprising one or more audio output devices integrated into one or more corners of the safety drop cloth.

16. The device according to claim 15, wherein the controller causes an audible alert message to be output by the one or more audio output devices.

17. The device according to claim 15, wherein the alert message comprises an audible alert message having audible content that is related to a hazard for which the safety drop cloth has been deployed.

18. The device according to claim 17, further comprising one or more sensors that sense proximity of an individual to the safety drop cloth, wherein the color is displayed when the individual enters a hazard zone around the safety drop cloth.

19. The device according to claim 14, further comprising a communications interface in combination with the controller, wherein the controller transmits any of an audible alert message and another type of alert message to a mobile device through the communications interface.

20. The device according to claim 14, wherein the mobile device is located in a defined proximity to the safety drop cloth.
